(19) United States
(12) Patent Application Publication
(10) Pub. No.: US 2026/0015883 A1
(43) Pub. Date: Jan. 15, 2026

(54) MOBILE UMBRELLA BASE

(71) Applicant: Michael Patrick NEVIN, Constantia (ZA)

(72) Inventor: Michael Patrick NEVIN, Constantia (ZA)

(21) Appl. No.: 18/875,265

(22) PCT Filed: Jun. 22, 2023
(86) PCT No.: PCT/IB2023/056480

§ 371 Date: Dec. 16, 2024

(30) Foreign Application Priority Data
Jun. 22, 2022 (ZA) 2022/06906

(51) Int. Cl. E04H 12/22; A45B 23/00; F16M 11/42

(52) U.S. Cl. CPC E04H 12/2238; A45B 23/00; F16M 11/42; A45B 2023/0031; E04H 12/2261; F16M 2200/08

(57) ABSTRACT

The invention is for an umbrella base (10) that is transported in a flat pack and is assembled by attaching two brace elements (22) to end plate assemblies (22) to form a frame and then loading store-bought slabs (52) onto the frame to serve as ballast elements. The end plate assemblies (20) include castors (36) that provide mobility and the umbrella base (10) includes a deck (18), so that the ballast elements (52) are covered.

### FIELD OF INVENTION

This invention relates to bases for umbrellas such as garden umbrellas and the like and more specifically, the invention relates to mobile bases for umbrellas.

While this invention is described and illustrated with reference to cantilever umbrellas with radial arms, it can be applied to all umbrella types.

### BACKGROUND TO THE INVENTION

There are many umbrella base types that are designed to satisfy the requirement of keeping the umbrella stable in an upright orientation. There are also several base types designed to provide mobility for the umbrella. These include pure-mass solutions such as a single concrete ballast through to lightweight steel frames that can be loaded-up with ballasts such as store-bought concrete paving slabs to provide ballast.

The benefits of the single concrete ballast option include that it is spatially efficient (i.e. it can be compact) and it can be mobile, but it holds the disadvantage that it is extremely costly and difficult to transport the heavy bases.

The benefit of the frame and store-bought ballast system is that it is easier and more cost-effective to transport a frame and purchase the ballast elements locally, closer to where the umbrella base will be used, but the disadvantages are that it is visually ungainly, difficult to mobilize and structurally inefficient to the extent that frame structures are designed with large footprints to provide strength and stability.

Currently available umbrella bases come in an array of configurations, from single ballast elements of various sizes and shapes to frame-like structures that require loose ballast elements. These umbrella bases provide varying degrees of structural stability, movability, space optimization, ease of delivery and neatness/aesthetic appeal, but they also hold several disadvantages, including:
The manufacturing technologies include complicated welded frame structures, expensive castings using high-tech materials or are crude concrete castings.
Heavy bases are difficult to handle and therefore expensive to deliver and require more than 1 person to assemble and move.
They are unsightly.
Frame-type structures have a large footprint.
Frame-type structures are structural inefficient.
These systems are mostly immobile and those that can be moved mostly require much effort.

The present invention seeks to provide an umbrella base that: is light and convenient to transport; can quickly and easily assembled on site; can accommodate ballast elements; occupies a small footprint; is highly mobile; and/or that is aesthetically sophisticated and attractive in its final assembled configuration.

### SUMMARY OF THE INVENTION

According to the present invention there is provided an umbrella base comprising:
two end plate assemblies, each of said end plate assemblies including an elongate end plate with two opposing ends, two rotating castors that are attached to the end plate at its opposing ends, at least two brace attachment formations provided in the vicinities of the two opposing ends of the end plate, and deck attachment formations provided at a top edge of the end plate;
two elongate brace elements with opposing ends, one end of each of said brace elements being attachable to one of the brace attachment formations of one of the end plates, and the other end of each of said brace elements being attachable to the one of the brace attachment formations of the other of said end plates, so that the end plates are held in a spaced-apart configuration with the brace elements extending between them, and the brace elements are spaced apart, with a central zone defined between the spaced apart end plates and the spaced apart brace elements;
a plurality of seat protuberances that protrude inwardly towards the central zone from opposing sides of the central zone from at least two locations on the end plates and brace elements; and
a deck that is attachable to the deck attachment formations of the end plates;
wherein the deck is disposed above the central zone and is spaced above the seat protuberances.

The umbrella base may include a ballast comprising at least one rectangular ballast element that is supported on the seat protuberances, below the deck.

The seat protuberances may be in the form of lips that protrude inwardly from lower edges of the brace elements, towards the central zone and each brace element may have an L-shaped cross-sectional profile comprising two flanges and one of said flanges on each brace element may serve as one of the seat formations.

The umbrella base may include a support formation on a top surface of the deck, said support formation being configured to receive a lower end of an umbrella post.

The umbrella base may be in a kit form wherein the end plate assemblies, the brace elements and the deck are loose from one another, and the end plate assemblies and brace elements are held in close proximity on one side of the deck. The deck may have peripheral skirt formations that extend from a periphery of the deck towards an underside of the deck, and wherein said end plate assemblies and brace elements are at least partly surrounded by the skirt elements.

The invention extends to an umbrella assembly comprising the umbrella base described herein above and an umbrella with a post that is supported above the deck.

The umbrella may have an offset umbrella canopy.

### BRIEF DESCRIPTION OF THE DRAWINGS

For a better understanding of the present invention, and to show how it may be carried into effect, the invention will now be described by way of non-limiting example, with reference to the accompanying drawings in which:

FIG. 1 shows a three-dimensional view of an umbrella and an umbrella base according to the present invention, in a fully assembled configuration;

FIG. 2 shows a detail three-dimensional view of the umbrella base of FIG. 1;

FIG. 3 shows a three-dimensional view of some component parts of the umbrella base of FIG. 1;

FIG. 4 shows a three-dimensional view of the component parts of the umbrella base of FIG. 1, that are used to form a frame and deck of the umbrella base, the component parts being shown in a compact flat-pack configuration;

FIG. 5 shows an exploded three-dimensional view of the umbrella base of FIG. 1 in an unassembled configuration, including the frame, deck and store-bought ballast stones of the umbrella base;

FIG. 6 shows a three-dimensional view of the umbrella base of FIG. 5 in a first partially assembled configuration, with bracing elements of the frame attached to end plates of the frame;

FIG. 7 shows a three-dimensional view of the umbrella based of FIG. 6 in a second partially assembled configuration, with the frame assembled prior to loading with the ballast stones.

FIG. 8 shows a three-dimensional view of the umbrella base of FIG. 7 in a third partially assembled configuration, with the ballast stones loaded onto the frame;

FIG. 9 shows a three-dimensional view of the umbrella base of FIG. 8 in a fully assembled configuration, with the deck in place; and

FIG. 10 shows a three-dimensional view of the fully assembled umbrella base of FIG. 9 with the umbrella attached to the umbrella base.

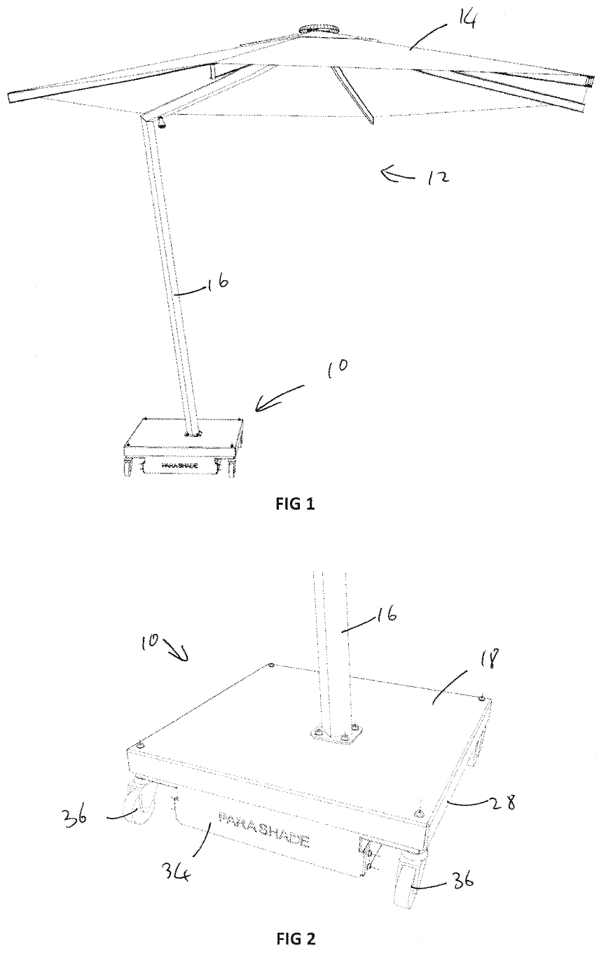

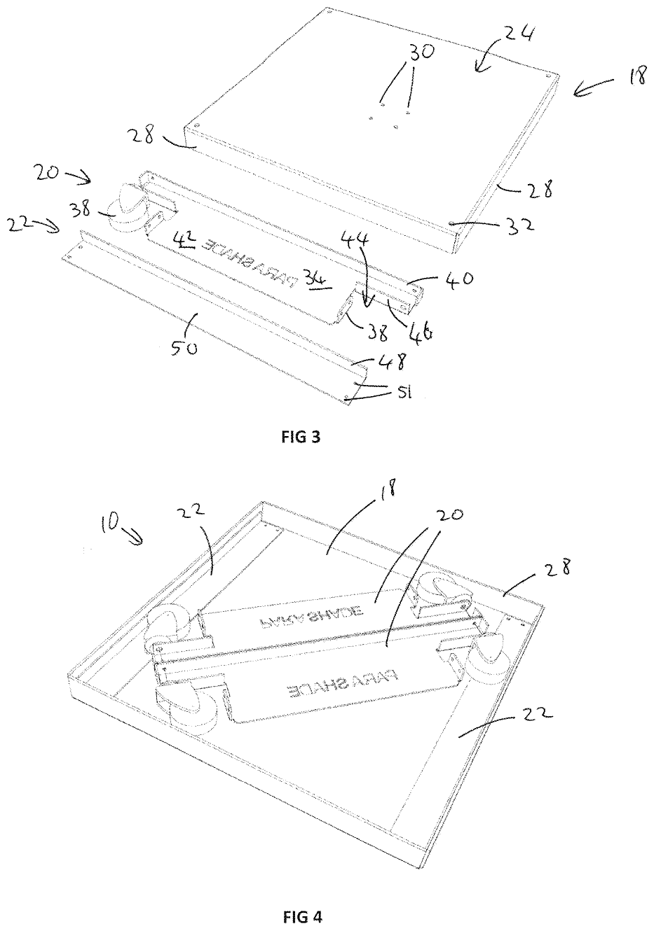

### DETAILED DESCRIPTION OF THE DRAWINGS

Referring to the drawings, an umbrella base according to the present invention is identified, generally, by reference number 10 and an umbrella for use with the umbrella base is identified by reference number 12. The umbrella includes a canopy 14 and post 16.

The umbrella base 10 comprises a top plate or deck 18, two end plate assemblies 20, two brace elements 22 and ballast elements 24.

The deck 18 has a top surface 24 and an opposing underside 26 and a return flange or skirt 28 extends along a periphery of the deck 18 towards the underside. Threaded fixing points 30 which serve as support formations for supporting the umbrella post 16 and four oversized fixing holes 32 for attaching the deck 18 to the end plate assemblies 20.

The deck 18 is shown rectangular in the illustrated embodiment of the invention and this is a cost-effective and practical shape, but the deck can have different shapes. The deck 18 is preferably formed from steel plate or other suitable durable metal, but it can potentially be made of other durable material. The terms “top surface” and “underside” are used herein with reference to the normal, upright orientation of the umbrella base 10 in use.

Each end plate assembly 20 includes an elongate end plate 34 with two opposing ends, two rotating castors 36 that are attached to the end plate at its opposing ends. Each end plate 34 is preferably recessed at its ends to accommodate most of the castor in the recess. Next to each recess there is a brace attachment formation in the form of a vertical bracing tab 38 with threaded holes and along an upper edge of the end plate 34 there is a flange 40 with threaded holes, to serve as a deck attachment formation.

Each end plate 34 includes a central cover plate section 42 and at the top of each of the castor recesses 44 there is a castor support plate 46 that is parallel to the flange 40 and the castor 36 is supported by the support plate 46 at a fixing point.

The two brace elements 22 each comprises a vertical flange 50 which has, on each extremity, two threaded fixing points 52 that align with the two holes on the bracing flanges 38 of the end plate assemblies 22 for attaching the ends of the brace elements to the end plate assemblies. Each brace element 22 also has a horizontal flange 48 that protrudes inwardly when the brace element is attached to the end plate assemblies 20.

The end plates 34 and L-profiled brace elements 22 are preferably also formed from steel plate.

When the brace elements 22 are attached to the end plate assemblies 20, they form a rectangular frame with the brace elements spaced apart and the end plate assemblies spaced apart and a central zone between them. The horizontal flanges 48 of the brace elements 22 form seat elements that protrude inwards towards the central zone. In other embodiments of the invention, the frame could include more or differently configured seat elements that protrude inwards to the central zone, from the brace elements 22 and/or the end plate assemblies 20. When the deck 18 is attached to the frame, it is spaced above these seat elements.

The umbrella base 10 include a ballast comprising one or more ballast elements 52 that are preferably in the form of one or more rectangular concrete slabs-preferably of a standard size that is readily available at stores and preferably have standard sizes. In the illustrated embodiment, the ballast elements 52 are a combination of 200×400×40 and 400×400×40 concrete paving slabs. The ballast elements 52 are supported on the horizontal flanges 48 or other seat protuberances, below the deck 18.

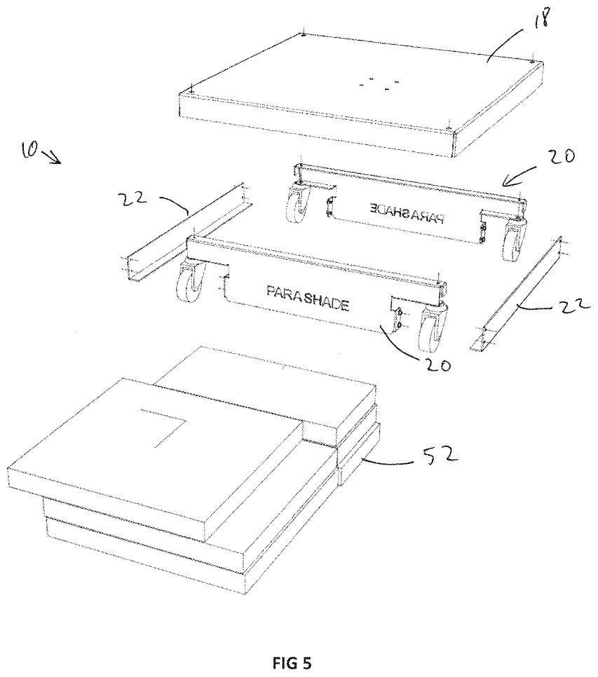

Referring to FIG. 4, the umbrella base 10 is transported in a flat pack kit form without the ballast elements 52, with the end plate assemblies 20 and the brace elements 22 stored on the underside of the deck 18, preferably in a space that is surrounded by the skirt 28 of the deck. The purpose of this invention is to provide a lightweight umbrella base that can be compactly and efficiently transported and delivered and this kit form serves that purpose.

Referring to FIGS. 5 to 9, the umbrella base 10 is assembled. Apart from providing a lightweight umbrella base that can be compactly and efficiently transported and delivered, the invention provides an umbrella base that, once delivered, can be easily assembled, including loaded with locally available, store-bought, paving slab ballast elements 52 and, on completion provide a compact and visually appealing fully mobile umbrella base 10.

FIG. 4 shows the flat-pack packaging configuration of the umbrella base 10, with the deck 18 upside-down and inside the deck, the two end plate assemblies 20 complete with castors 36 as well as the two brace elements 22. Also to be included are the necessary fixing and fastenings. This is the package that will arrive at the client, ready for assembly.

FIG. 5 shows the components for the assembly of the umbrella base 10 in exploded configuration with the store-bought ballast paving slabs 52, the end plate assemblies 20 shown in the upright position, the brace elements 22 either side and the deck 18.

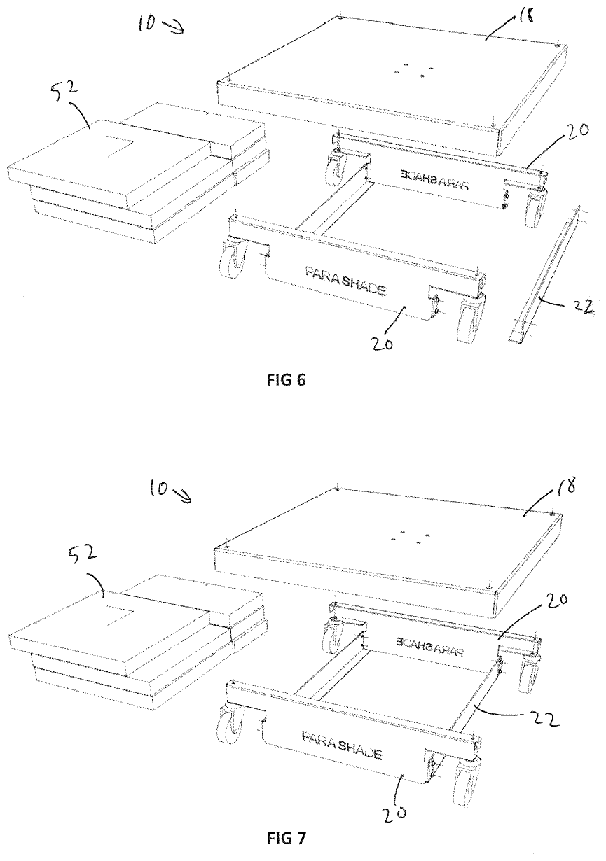

FIG. 6 shows the start of the assembly process, with the first brace element 22 in position for attaching it to the end plate assemblies 20. The holes in the tabs 38 of the end plate assemblies 20 are aligned with the threaded fixing points 51 in the brace elements 22 and these are attached with bolts.

FIG. 7 shows the second brace element 22 attached similarly to FIG. 6 to provide the frame of the umbrella base 10.

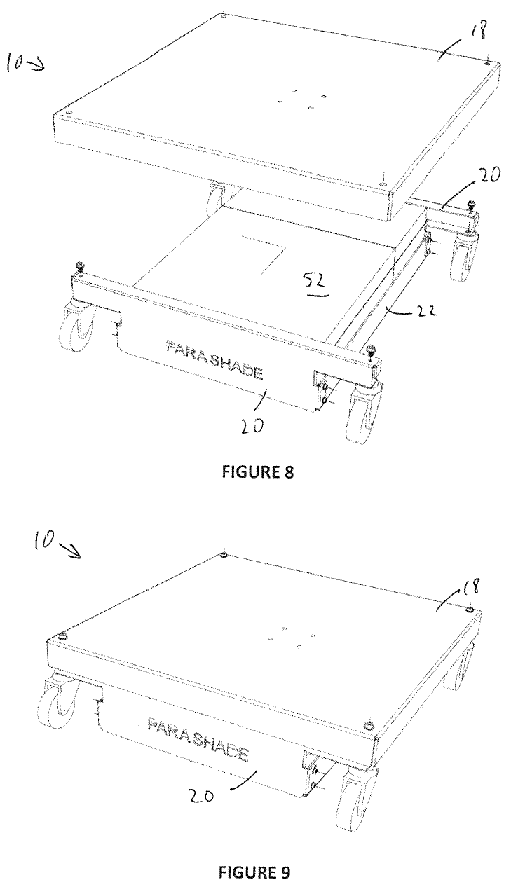

FIG. 8 shows the store-bought paving slab ballast elements 52 loaded into the central zone of the completed frame with the deck 18 about to be attached.

FIG. 9 shows the deck 18 in position and attached to the frame with bolts through the oversized holes 32 and secured into the threaded fixing points on the flanges 40 of the end plates 34.

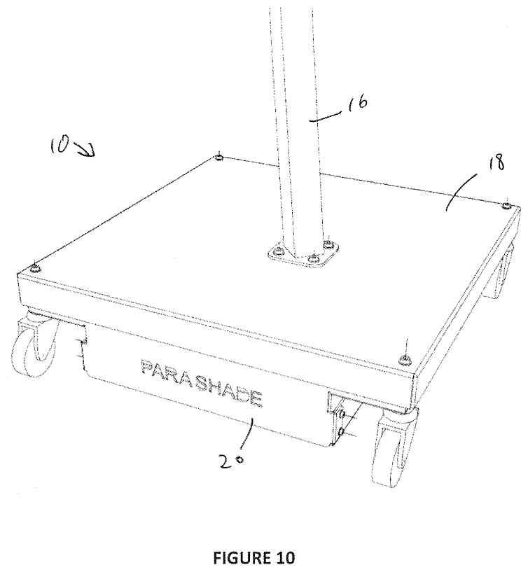

FIG. 10 shows the completed umbrella base 10 with the umbrella post 16 secured to the deck 18 with bolts securely bolted into the threaded holes 30 in the deck.

The assembly of the umbrella base 10 comprises these steps:

Before assembling the umbrella base 10, it will be necessary to procure the correct size and number of locally available paving slabs to serve as ballast elements 52.

Step 1 is to attach the brace elements 22 to the end plates 34 with all flanges 48 facing inwards. The fixing holes in the tabs 38 on the end plates 34 are aligned with and securely fixed to the fixing points 51 in the brace elements 22. The frame is now ready for loading with store-bought paving slabs 52.

Step 2 is to load the frame with the store-bought paving slabs 52.

Step 3 is to position the deck 18 and fix this to the end plate assemblies 20 through the oversized fixing point holes 32 in the corners of the top surface 24 with fasteners that are driven into the threaded holes in the flanges 40 of the end plate assemblies 20.

Step 4 is to attach the umbrella post 16 to the deck 18 by securing it into the post fixing points 30. In the illustrated embodiment there are four fixing points 30, but this may vary.

Step 5 is to attach the umbrella canopy 14 onto the post 16.

The umbrella 12 may be a cantilever umbrella, i.e. it may have an offset umbrella canopy, but the invention also works with umbrellas with central posts and different canopies.

The illustrated invention holds the following advantages:
This system is easy to manufacture with no welded parts.
It can be delivered in a compact box that can be carried by a single person.
It is easy to assemble by 1 person.
It is neat and attractive.
Provides a ridged and stable structure for the umbrella.
Once assembled, is easy to move as required.

In short, this invention is a high-tech, simple, easy to assemble base solution that is attractive and, extremely importantly, highly mobile.

1. An umbrella base comprising:
two end plate assemblies, each of said end plate assemblies including an elongate end plate with two opposing ends, two rotating castors that are attached to the end plate at its opposing ends, at least two brace attachment formations provided in the vicinities of the two opposing ends of the end plate, and deck attachment formations provided at a top edge of the end plate;
two elongate brace elements with opposing ends, one end of each of said brace elements being attachable to one of the brace attachment formations of one of the end plates with a threaded fastener, and the other end of each of said brace elements being attachable to the one of the brace attachment formations of the other of said end plates with a threaded fastener, so that the end plates are held in a spaced-apart configuration with the brace elements extending between them when the brace elements are attached to the attachment formations of the end plates, and the brace elements are spaced apart, with a central zone defined between the spaced apart end plates and the spaced apart brace elements when the brace elements are attached to the attachment formations of the end plates;
a plurality of seat protuberances that protrude inwardly towards the central zone from opposing sides of the central zone from at least two locations on the end plates and brace elements; and
a deck that is attachable to the deck attachment formations of the end plates with threaded fasteners such that;
wherein the deck is disposed above the central zone and is spaced above the seat protuberances when the deck is attached to the deck attachment formations;
wherein the umbrella base is in a kit form in which the end plate assemblies, the brace elements and the deck are loose from one another, and the end plate assemblies and brace elements are held in close proximity to an underside of the deck,
wherein the deck has peripheral skirt formations that extend from a periphery of the deck towards the underside of the deck, said skirt formations extending at least partly around a cavity, and
wherein said end plate assemblies and brace elements are stored in said cavity and are at least partly surrounded by the skirt elements when the umbrella base is in said kit form.

2. The umbrella base of claim 1, which includes a ballast comprising at least one rectangular ballast element that is supported on the seat protuberances, below the deck when the umbrella base has been assembled from its kit form.

3. The umbrella base of claim 1, wherein the seat protuberances are in the form of lips that protrude inwardly from lower edges of the brace elements, towards the central zone.

4. The umbrella base of claim 3, wherein each brace element has an L-shaped cross-sectional profile comprising two flanges and one of said flanges on each brace element serving as one of the seat formations.

5. The umbrella base of claim 1, which includes a support formation on a top surface of the deck, said support formation being configured to receive a lower end of an umbrella post.

6-9. (canceled)
